(19) United States
(12) Patent Application Publication
(10) Pub. No.: US 2018/0157117 A1
(43) Pub. Date: Jun. 7, 2018

(54) DISPLAY DEVICE INCLUDING BACKLIGHT UNIT

(71) Applicant: Samsung Display Co., Ltd., Yongin-si (KR)

(72) Inventors: Seong Koo JEONG, Hwaseong-si (KR); Kyoung Ho PARK, Seoul (KR); Ji Woong CHOI, Incheon (KR)

(21) Appl. No.: 15/828,557

(22) Filed: Dec. 1, 2017

(30) Foreign Application Priority Data
Dec. 5, 2016 (KR) 10-2016-0164327

(51) Int. Cl. G02F 1/1335; F21V 8/00

(52) U.S. Cl. CPC G02F 1/133602; G02B 6/0025; G02F 1/133524

(57) ABSTRACT

A display device includes: a display panel; and a backlight unit which supplies light to the display panel. The backlight unit includes: a bottom chassis; a light source module disposed along an edge portion of the bottom chassis and including a light source which generates and emits light; and a light guide which is disposed on the bottom chassis and transfers the light emitted from the light source to the display panel. At the edge portion of the bottom chassis, the light source module is disposed between the bottom chassis and the light guide to overlap the light guide, and a main light-emitting surface of the light source faces a side wall of the bottom chassis adjacent to the light source module.

This application claims priority to Korean Patent Application No. 10-2016-0164327 filed on Dec. 5, 2016, and all the benefits accruing therefrom under 35 U.S.C. § 119, the content of which in its entirety is incorporated herein by reference.

### BACKGROUND

### (a) Field

This disclosure relates to a backlight unit and a display device including the same.

### (b) Description of the Related Art

A liquid crystal display (“LCD”) is one of the most commonly used display devices. The liquid crystal display is an apparatus that displays an image by adjusting transmittance of light by applying an electric field to a liquid crystal panel including a liquid crystal layer to change the arrangement of liquid crystal molecules. Since the liquid crystal panel is non-emissive, the liquid crystal display generally includes a backlight unit for supplying light to the liquid crystal panel from a rear surface of the liquid crystal panel.

The backlight unit is divided into an edge type and a direct type depending on a position of the light source with respect to the liquid crystal panel. The edge type backlight unit is a type in which a light source is positioned at the side of a light guide plate, and the direct type backlight unit is a type in which the light source is positioned under the light guide plate. In terms of space utilization and design, there is a demand for a display device having a thinner bezel and smaller overall thickness. Typically, the direct type backlight unit is advantageous for implementing a relatively thin bezel, and the edge type backlight unit is advantageous for implementing a relatively thin thickness.

### SUMMARY

Exemplary embodiments provide a display device having a relative thin bezel and small thickness, and including a backlight unit. An exemplary embodiment provides a display device including: a display panel; and a backlight unit which supplies light to the display panel. The backlight unit includes: a bottom chassis; a light source module disposed along an edge portion of the bottom chassis and including a light source; and a light guide which is disposed on the bottom chassis and transfers the light emitted from the light source. At the edge portion of the bottom chassis, the light source module is disposed between the bottom chassis and the light guide to overlap the light guide, and a main light-emitting surface of the light source faces a side wall of the bottom chassis adjacent to the light source module.

A light-emitting surface of the light guide may define a main surface thereof, the light source module may include a substrate defining a main surface thereof on which the light source is mounted, and the main surface of the substrate may be perpendicular to the main surface of the light guide.

The bottom chassis may include a main portion which is flat and a side portion integral with the main portion to have a U-shaped cross-section extended away from the main portion, and the light source module may be disposed in the side portion.

The side portion may include: a first portion which downwardly extends from the main portion; a second portion which outwardly extends from the first portion to be parallel with the main portion; and a third portion which from the second portion to be parallel with the first portion.

A hole may be defined in the third portion of the side portion.

The backlight unit may further include a reflective member between the third portion and the light source module, in the side portion.

The reflective member may have a C-shaped cross-section and a length of the reflective member may correspond to that of the light source module.

The reflective member may include: a first portion which contacts the second portion of the side portion; a second portion which contacts the third portion of the side portion; and a third portion which inwardly extends from the second portion of the reflective member to be parallel with the first portion of the reflective member.

The reflective member may include a reflective layer at an inner surface thereof.

The backlight unit further may include a refractive index matching member between the reflective member and the light source module, in the side portion.

The refractive index matching member may have a same refractive index as that of the light guide.

The light guide may include a light-incident end surface facing the edge portion of the bottom chassis along which the light source module is disposed, the backlight unit may further include a reflective sheet disposed between the bottom chassis and the light guide, and the refractive index matching member may contact the reflective layer, the light source module, the light-incident end surface of the light guide, and a lower surface of the reflective sheet.

The reflective sheet may overlap the light source module.

The backlight unit may further include a support which is disposed between the substrate and the first portion of the side portion to be in contact with the substrate and the first portion of the side portion, and the main light-emitting surface of the light source and the main surface of the substrate may be parallel.

The backlight unit may further include: a frame disposed between the light guide and the display panel; and an optical sheet disposed between the frame and the display panel.

A light-emitting surface of the guide may define a main surface thereof, the light source module may include a substrate defining a main surface thereof on which the light source is mounted, and the main surface of the substrate may be in parallel with the main surface of the light guide. The main light-emitting surface of the light source may be perpendicular to the main surface of the substrate.

According to one or more of the exemplary embodiments of a backlight unit, it is possible to reduce the bezel width and an overall thickness of the display device including the backlight unit.

### BRIEF DESCRIPTION OF THE DRAWINGS

The above and other advantages and features of this disclosure will become more apparent by describing in further detail exemplary embodiments thereof with reference to the accompanying drawings, in which:

FIG. 1 schematically illustrates a top plan view of an exemplary embodiment of a display device according to the invention.

FIG. 2 is an exploded perspective view of the display device illustrated in FIG. 1.

FIG. 3 illustrates an enlarged cross-sectional view of the display device taken along line III-III′ of FIG. 1.

FIG. 4, FIG. 5 and FIG. 6 illustrate an exemplary embodiment of a manufacturing process of a display device according to the invention.

FIG. 7 illustrates an enlarged cross-sectional view of another exemplary embodiment of a display device taken along line III-III′ of FIG. 1.

### DETAILED DESCRIPTION

The invention will be described more fully hereinafter with reference to the accompanying drawings, in which exemplary embodiments of the invention are shown. As those skilled in the art would realize, the described embodiments may be modified in various different ways, all without departing from the spirit or scope of the invention.

To clearly describe the invention, parts that are irrelevant to the description are omitted, and like numerals refer to like or similar constituent elements throughout the specification.

Further, since sizes and thicknesses of constituent members shown in the accompanying drawings are arbitrarily given for better understanding and ease of description, the invention is not limited to the illustrated sizes and thicknesses. In the drawings, the thickness of layers, films, panels, regions, etc., are exaggerated for clarity. In the drawings, for better understanding and ease of description, the thicknesses of some layers and areas are exaggerated.

It will be understood that when an element such as a layer, film, region, or substrate is referred to as being related to another elements such as “on” another element, it can be directly on the other element or intervening elements may also be present. In contrast, when an element is referred to as being related to another elements such as being “directly on” another element, there are no intervening elements present. Further, the word “over” or “on” means positioning on or below the object portion.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “At least one” is not to be construed as limiting “a” or “an.” “Or” means “and/or.” As used herein, the term “and/or” includes any and all combinations of one or more of the associated listed items. In addition, unless explicitly described to the contrary, the word “comprise” and variations such as “comprises” or “comprising” will be understood to imply the inclusion of stated elements but not the exclusion of any other elements.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10% or 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Further, in the specification, the phrase “in a plan view” means when an object portion is viewed from above, and the phrase “in a cross-section” means when a cross-section taken by vertically cutting an object portion is viewed from the side.

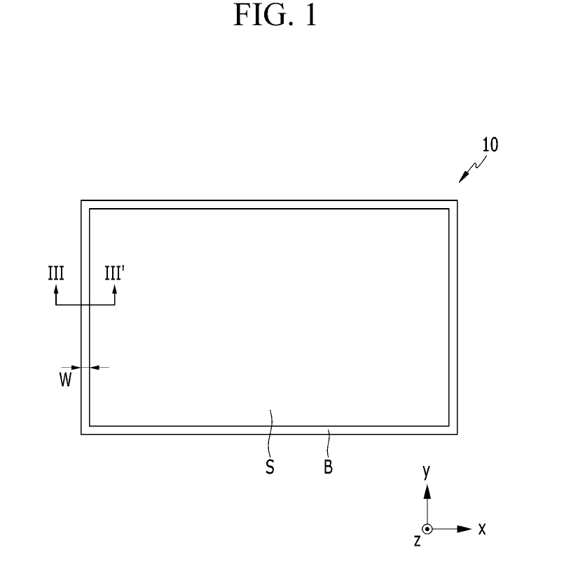

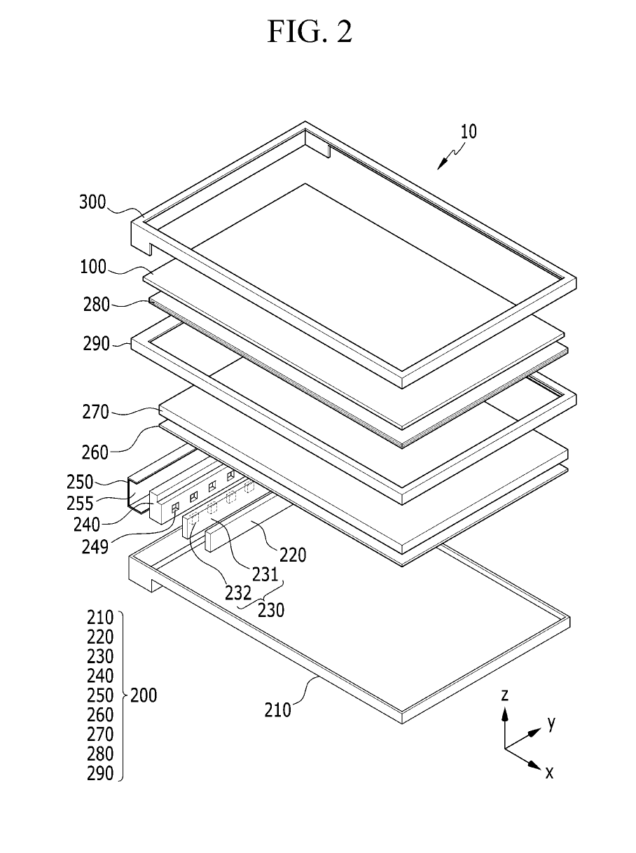

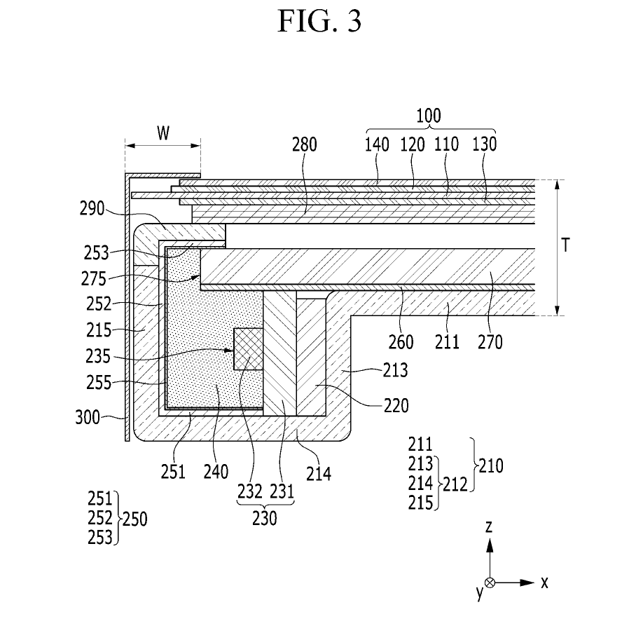

FIG. 1 schematically illustrates a top plan view of an exemplary embodiment of a display device according to the invention, FIG. 2 is an exploded perspective view of the display device illustrated in FIG. 1, and FIG. 3 illustrates an enlarged cross-sectional view of the display device taken along line III-III′ of FIG. 1.

FIG. 1 is a top plan view illustrating a front surface of a display device 10. The display device 10 is generally rectangular, but may have various shapes without being limited thereto. In an exemplary embodiment, for example, the display device 10 may have at least one rounded corner without being angulated. The display device 10 and constituent elements thereof may be disposed in a plane defined by a first direction (e.g., x-direction) and a second direction (e.g., y-direction). A thickness of the display device 10 and constituent elements thereof may be defined in a third direction (e.g., z-direction) which crosses each of the first and second directions. In an exemplary embodiment, the first to third directions may be orthogonal to each other, without being limited thereto.

In the display device 10, a screen “S” on which an image is displayed with light is surrounded by a bezel “B”. The screen S may correspond to a display area at which the image is displayed, and the bezel B may correspond to a non-display are at which the image is not displayed. The screen S is generally rectangular, but may have various shapes without being limited thereto. When the display device 10 is viewed from the front surface (e.g., a viewing side or light-emitting side of the display device 10), the bezel B may indicate a region other than the screen S, e.g., may correspond to an outer frame different from the screen S. A planar area of the screen S and the bezel B may together form a total planar area of the display device 10 in the top plan view.

Portions of the bezel B lengthwise extend in a direction (e.g., x-direction or y-direction) and a width of the bezel B is taken perpendicular to a respective length portion thereof. Referring to FIG. 1, when the display device 10 is viewed from the front surface, the bezel B has a predetermined width W. The width W of the bezel B may be substantially the same at all (e.g., for four sides) edges of the screen S, or may be different for at least two sides. The width W of the bezel B may be substantially zero at any edge. As the width W of the bezel B is relatively smaller within a total planar area of the display device 10, a larger screen S can be realized in the display device 10 of the same overall size. In addition, a degree of immersion for the user viewing an image displayed by the display device 10 may be increased because the screen occupies a maximum planar area of that of the overall display device 10. In a case of a tiled display in which a plurality of display devices are arranged in a contiguous manner to provide a relatively large overall screen, recognizing a boundary between the display devices may be advantageously difficult as the width W of the bezel B is reduced in each of the display devices.

FIG. 2 is an exploded perspective view schematically illustrating a general shape of a plurality of constituent elements constituting the display device 10 illustrated in FIG. 1, and FIG. 3 is an enlarged cross-sectional view illustrating a vicinity of the edge of the display device 10 (hereinafter referred to as “light-incident portion”) where a light source module 230 in the display device 10 illustrated in FIG. 1 is disposed or formed.

The light-incident portion may be positioned relative to at least one edge of the display device 10. In an exemplary embodiment, for example, the light-incident portion may be positioned at one relatively short side or at each of two relatively short sides of the display device 10, or may be positioned at one relatively long side or at each of two relatively long sides of the display device 10. Herein, an example where the light-incident portion is positioned at one side (a left side in FIG. 1) of the display device 10 is provided. In a case where the light-incident portion is also positioned at a short side of the display device 10 opposite to the one side, a structure of the light-incident portion positioned at the opposite short side may be substantially symmetrical to that shown in FIG. 3 with respect to the screen S.

Referring to FIG. 2 and FIG. 3, the display device 10 basically includes a display panel 100 and a backlight unit 200. The display panel 100 is a light-receiving display panel such as a liquid crystal panel without being limited thereto. The backlight unit 200 generates light and supplies the light to the display panel 100, and the display panel 100 displays an image by adjusting transmittance of the supplied light. The display device 10 further includes a top chassis 300 that surrounds at least a part of a rim of the display panel 100. The top chassis 300 may protect the display panel 100, and may reduce or effectively prevent the display panel 100 from being separated from the backlight unit 200.

When the display device 10 is viewed from the front surface, the top chassis 300 may correspond to the bezel B, and a width of the top chassis 300 taken similarly that described above for the bezel B may correspond to the width W of the bezel B. The top chassis 300 may be referred to as a front cover, and may be omitted. A rear cover (not illustrated) may be disposed in a rear surface of the backlight unit 200 to cover a power supply (not illustrated), a driver (not illustrated) which drives or operates the display device 10, and the like.

The display panel 100 may be a liquid crystal display panel in which a liquid crystal layer is disposed or formed between two transparent (base) substrates 110 and 120 in which are disposed or formed switching elements, electrodes, color filters, and the like. The substrates 110 and 120 may include or be divided into pixels which are driven or controlled to display an image with light. Polarization layers 130 and 140 are respectively disposed on surfaces of the substrates 110 and 120, such as outer surfaces thereof. The display panel 100 displays image with light generated and provided by the backlight unit 200 by adjusting transmittance of light passing through the polarization layer 130, the liquid crystal layer, and the polarization layer 140 under control of the driver at the pixels as units of display within the display device 10, for example.

The backlight unit 200 is disposed below the display panel 100 to generate and supply light to the display panel 100. The backlight unit 200 includes a bottom chassis 210, a support 220, the light source module 230, and optical elements 240, 250, 260, 270 and 280 through which light emitted from the light source module 230 is provided to the display panel 100.

The bottom chassis 210 is a kind of container having an open upper portion and including an accommodating space of a predetermined depth in the third direction. The bottom chassis 210 may generally have, e.g., a quadrangular tray-like shape. The bottom chassis 210 may be substantially flat overall, and may include a bent portion at the light-incident portion in which the light source module 230 is disposed or formed. Specifically, the bottom chassis 210 includes a substantially flat main portion 211. At the light-incident portion of the display device, the bottom chassis 210 includes a “U”-shaped side portion 212 in cross-section. The main portion 211 and the side portion 212 are integrally formed. That is, a portion of one of the main portion 211 and the side portion 212 extends to define the other one of the main portion 211 and the side portion 212. The side portion 212 corresponding to the light-incident portion is disposed or formed to define a trench lengthwise extended along one edge of the bottom chassis 210.

The main portion 211 may include a partially protruded or depressed portion (not illustrated) for fixing or supporting a constituent element disposed thereon at a predetermined height. The side portion 212 includes a first portion 213 downwardly extended from the main portion 211, a second portion 214 extended outwardly from the first portion 213 to be disposed substantially parallel to the main portion 211 (e.g., in a direction away from a center of the bottom chassis 210 or the screen S of the display device 10), and a third portion 215 extended upwardly from the second portion 214 to be disposed substantially parallel to the first portion 213. The third portion 215 corresponds to a side wall of the bottom chassis 210. A total height of the third portion 215 may be greater than that of the first portion 213, such as taken in the third direction from the second portion 214, but is not limited thereto. The bottom chassis 210 may include or be formed of a metal material such as aluminum, an aluminum alloy or a galvanized steel sheet. The bottom chassis 210 may include or be formed of a plastic material such as a polycarbonate.

The support 220, the light source module 230, a refractive index matching member 240, a reflective member 250, a reflective sheet 260, a light guide 270, an optical sheet 280 (member) and a frame 290 are accommodated at or fixed in the bottom chassis 210. Among them, the support 220, the light source module 230, the refractive index matching member 240 and the reflective member 250 are disposed at the light-incident portion of the display device 10, and are substantially disposed in an inner space defined by the side portion 212 of the bottom chassis 210.

The support 220 is disposed or formed to lengthwise extend along the length of the first portion 213 of the side portion 212. The support 220 is disposed between the light source module 230 and the first portion 213 of the side portion 212 of the bottom chassis 210. The support 220 generally has an elongated-bar shape, but the support 200 may have other shapes. The support 220 has a relatively large surface (hereinafter a maximum planar area one forming a 3D structure is referred to as a main surface) fixedly attached to the first portion 213 of the side portion 212. Referring to FIGS. 1 to 3, the main surface of the support 220 is disposed in a plane parallel to that defined by the y-direction and the z-direction, such as that surface facing the first portion 213 or facing the third portion 215. The support 220 is a heat dissipation component for fixing the light source module 230 within the backlight unit 200 and transferring heat generated from the light source module 230 to the bottom chassis 210.

The support 220 may include or be formed of a metal material having relatively good thermal conductivity in order to rapidly transfer the heat from the light source module 230 to the bottom chassis 210, thereby reducing or effectively preventing the light source module 230 from being overheated. In an exemplary embodiment of manufacturing a display device, for example, the support 220 may be formed by extrusion molding a material such as aluminum, an aluminum alloy or the like. In an exemplary embodiment, the support 220 may be fixed to the bottom chassis 210 by a fastening member such as a screw without being limited thereto.

The light source module 230 includes a substrate 231 and a light source 232 provided in plurality mounted thereon. The substrate 231 supplies power to the light sources 232 while supporting the light sources 232 thereon. The substrate 231 may be a circuit board, e.g., a metal core printed circuit board (“MCPCB”). The substrate 231 may have an elongated-bar shape that generally has a narrow width. Referring to FIGS. 1 to 3, a main surface of the substrate 231 is disposed in a plane parallel to that defined by the y-direction and the z-direction, such as that surface facing the support 220 or facing the third portion 215. The substrate 231 is fixed such that a back (main) surface thereof is in close proximity to with the support 220, such as being in contact with the support 220. The light sources 230 are mounted on a front (main) surface of the substrate 231. The substrate 231 is in close proximity such as in contact with the supporter 220, and the support 220 is in close proximity to the bottom chassis 210 such as being in contact with the bottom chassis 210. Accordingly, heat generated from the light sources 232 may be quickly transferred to the bottom chassis 210 through the substrate 231 and the support 220, to be discharged from the backlight unit 200 and/or the display device 10. As a result, the substrate 231, the support 220 and the bottom chassis 210 may together function as a heat sink for heat which is generated by the light sources 232.

The light source 232 is electrically connected to a conductive element such as a wire (not illustrated) of the substrate 231 to receive power from the substrate 231, and converts electrical energy into light energy to generate and emit light. The light source 232 may be a light emitting diode (“LED”) package, and may be disposed at a predetermined interval on a length of a single one substrate 231. The light source 232 may emit white light, or may emit blue light or ultraviolet (“UV”) light. In addition to the LED package, a point light source or a linear light source may be employed as the light source 232.

The light source 232 is positioned such that a surface thereof from which light is mainly emitted (hereinafter referred to as a “main light-emitting surface 235”) faces a side wall of the bottom chassis 210 that is adjacent to the light source module 230. Specifically, the main light-emitting surface 235 of the light source 232 is positioned to face the third portion 215 of the side portion 212, such that the light source 232 substantially emits light toward the third portion 215 of the side portion 212 and away from the screen S of the display device 10. The third portion 215 corresponds to the side wall of the bottom chassis 210. The main light-emitting surface 235 of the light source 232 and the main (or back) surface of the substrate 231 may be parallel with each other.

The light guide 270 is disposed on the bottom chassis 210 such that an edge portion thereof is disposed above the light source module 230 to overlap the light source module 230. The light guide 270 is used to guide light emitted from the light source 232 and to transmit the light to the display panel 100. The light guide 270 serves to convert light having optical distribution such as a point light form or a linear light form into light having an optical distribution such as a surface light form, that is, serves to uniformly distribute light. Referring to FIGS. 1 to 3, a main surface of the light guide 270 is disposed in a plane parallel to that defined by the x-direction and y-direction. Light is emitted from the light guide 270 through an upper (main) surface thereof. A lower (main) surface of the light guide 270 is opposite to the light emitting (main) surface thereof, and side surfaces of the light guide 270 connect the light emitting surface and the rear surface to each other.

The reflective sheet 260 is disposed below the light guide 270, e.g., between the light guide 270 and the bottom chassis 210. The reflective sheet 260 serves to increase light efficiency by reflecting and scattering light traveling through a lower side of the light guide 270 to be finally directed toward the display panel 100. The reflective sheet 260 may have an overall planar shape corresponding to the light guide 270, such as having a substantially same planar area as the light guide 270. The reflective sheet 260 may be disposed to completely overlap the light guide 270. In an exemplary embodiment, for example, an edge of the reflective sheet 260 may substantially coincide with (e.g., be aligned with) an edge of the light guide 270.

The light source module 230 is disposed between the light guide 270 and the second portion 214 of the side portion 212 of the bottom chassis 210. An entirety of the light source module 230 may be disposed between the light guide 270 and the second portion 214 of the side portion 212 of the bottom chassis 210. The main light-emitting surface 235 of the light source 232 may be substantially perpendicular to the main surface of the light guide 270, such as that corresponding to the lower surface of the light guide 270. However, the main light-emitting surface 235 and the main surface of the light guide 270 need not necessarily be perpendicular to each other. In an exemplary embodiment, for example, the main light-emitting surface 235 of the light source 232 and the main surface of the light guide 270 may form an acute angle of, e.g., about 10° or more and less than about 90° with each other, such as an angle of about 30° or more and about 90° or less, or an angle of about 45° or more and about 90° or less. Since the light source module 230 is disposed to overlap the light guide 270 by being disposed below the light guide 270, the bezel width W is reduced such that a non-display area at an outer circumference of the screen S of the display device 10 may be reduced as compared with a structure in which the light source module 230 is disposed totally outside (e.g., non-overlapping) a planar area at a side surface of the light guide 270.

However, in this structure, the light source 232 is disposed below the light guide 270, and the main light-emitting surface 235 of the light source 232 is not positioned to face a light-incident (side surface) end portion 275 of the light guide 270 through which light emitted from the main light-emitting surface 235 of the light source 232 is introduced to the light guide 270. Both of the main light-emitting surface 235 of the light source 232 and the light-incident end portion 275 of the light guide 270 face an outer circumference of the bottom chassis 210 in substantially a same direction. Accordingly, light emitted from the light source 232 may not be directly introduced into the light guide 270, and may be reflected by the reflective member 250 and then introduced into the light guide 270.

The reflective member 250 is disposed between the light source module 230 and the third portion 215 of the side portion 212. The reflective member 250 reflects the light emitted from the light source 232 to transfer the emitted light toward the light-incident end portion 275 of the light guide 270. A reflection layer 255 may be attached to or coated on an inner surface of the reflective member 250, in order to improve reflection ability of the reflective member 250. The reflection layer 255 on the reflective member 250 may together constitute a reflective member of the display device 10. In an exemplary embodiment, for example, an attached reflective layer may be a reflective sheet tape on the reflective member 250, and a coated reflective layer may be formed by disposing a highly reflective metal material layer such as silver on the reflective member 250 as a base of the reflective member. The reflective layer 255 may have relatively high reflectance of, e.g., at least 90%, at least 95%, or at least 98% in order to minimize optical loss of light transmitted to the light guide 270.

The light emitted from the light source 232 may be reflected once by the reflecting member 250 and introduced directly into the light-incident end portion 275 of the light guide 270 from the reflecting member 250, or may be introduced into the light guide 270 after being scattered and/or reflected by a lower surface of the reflective sheet 260 and/or the substrate 231. Light introduced into the light guide 270 is emitted through the upper surface thereof, and then is supplied to the display panel 100 through the optical sheet 280.

The reflective member 250 may be disposed or formed to lengthwise extend along an edge of the bottom chassis 210 which is parallel with a length of the light source module 230, and may have a length that substantially corresponds to that of the light source module 230. The reflective member 250 may be in close proximity such as being in contact with an inner surface of the side portion 212 to have a substantially angulated “C”-shaped cross-section as shown in FIG. 3. In an exemplary embodiment, for example, the reflective member 250 includes a first portion 251 that contacts the second portion 214 of the side portion 212, a second portion 252 that contacts the third portion 215 of the side portion 212, and a third portion 253 that inwardly extends from the second portion 252 toward the light guide 270 to be substantially parallel with the first portion 251. At the side portion 212, the third portion 253 of the reflective member 250 may extend toward the light guide 270 to be disposed above the upper (light emitting) surface of the light guide 270, and may be in contact with a portion of the upper surface of the light guide 270

As a result, a reflective area of the reflective member 250 may be sufficiently wide, and leakage of light from at edge of the screen S may be effectively prevented. In addition, at the side portion 212, the reflective sheet 260 is also disposed below the light guide 270. Thus, introduction of the light reflected by the reflective member 250 through the lower surface of the light guide 270 is reduced or effectively prevented, thereby preventing light from leaking at the edge of the screen S.

The refractive index matching member 240 is disposed between the reflective member 250 and the light source module 230. The refractive index matching member 240 may substantially fill a space (hereinafter referred to as “a light-incident portion space”) defined by the light source module 230, the reflecting member 250, the reflecting sheet 260, and the light guide 270, at the side portion 212. Accordingly, the refractive index matching member 240 may contact surfaces of lower portions of the light source module 230, the reflective layer 255 and the reflective sheet 260, in addition to the light-incident end portion 275 of the light guide 270. The refractive index matching member 240 may include a recess 249 provided in plurality that respectively conform to a shape of the light source 232 protruded from the substrate 231 toward the refractive index matching member 240. In an exemplary embodiment, for example, in an exemplary embodiment of manufacturing a display device, the recessed structure of the refractive index matching member 240 may be formed by injecting a liquid resin into the light-incident portion space and curing it.

The refractive index matching member 240 serves to reduce light loss between the light source 232 and the light guide 270, and has a refractive index that is substantially identical or similar to that of the light guide 270. The light guide 270 may include or be formed of, e.g., polymethylmethacrylate (“PMMA”) having a refractive index of about 1.49 or polycarbonate (“PC”) having a refractive index of about 1.58.

The refractive index matching member 240 may have a refractive index corresponding to the refractive index of the light guide 270, and may have a refractive index of, e.g., about 1.4 to about 1.7, or about 1.45 to about 1.63. An optically transparent resin (“OCR”) may be used as a material having such a refractive index. In an exemplary embodiment, for example, a product SVR-1100, SVR-1320 or SV-1240H from Dexerials Corporation, or 2175, EAS-1616 or EAS-1614 from 3M Company may be employed as the optical transparent resin. These products have a refractive index of, e.g., about 1.52.

The refractive index of the optically transparent resin may be improved by adding a relatively high refractive index monomer including a benzene ring. Light emitted from the light source 232 passes through the refractive index matching member 240 until the passed light is reflected by the reflective layer 255 to be introduced into the light guide 270 through the light-incident end portion 275 thereof. The refractive index matching member 240 contacts the light-incident end portion 275 of the light guide 270, and thus the reflection caused by a difference in the refractive indexes at the light-incident end portion 275 may be effectively prevented or minimized to improve the light efficiency.

The frame 290 may be provided for stably supporting the display panel 100 at a constant height within the display device 10. The frame 290 may be fixedly coupled to the bottom chassis 210. The frame 290 is referred to as a mold frame or a middle mold.

The optical sheet 280 may be disposed above the frame 290. The optical sheet 280 may include a plurality of individual sheets, e.g., a diffuser sheet, a prism sheet and a protecting sheet. The diffuser sheet is used to uniformly distribute the light emitted from the light guide plate 270 to make the luminance distribution uniform, that is, to make a surface light source of uniform brightness. The prism sheet serves to adjust a traveling direction of the light diffused by the diffusion sheet to be perpendicular to the display panel 100. The protecting sheet may be used to protect a prism of the prism sheet from scratches and the like. The protective sheet may also function to diffuse the light to widen the viewing angle narrowed by the prism sheet. The optical sheet 280 may omit either of the prism sheet and the protective sheet, or may include one or more thereof. The optical sheet 280 may further include a reflective polarizing sheet capable of enhancing the luminance efficiency by separating, transmitting, and reflecting the polarized light component of light. The optical sheet 280 may have an overall planar area or shape corresponding to the light guide 270.

The display panel 100 is positioned above the optical sheet 280, and the top chassis 300 is positioned to surround a rim of the display panel 100. The top chassis 300 may be fixedly coupled to the bottom chassis 210, a back cover and the like.

The width W (refer to FIG. 3) of the top chassis 300 may correspond to the bezel width (W in FIG. 1) of the display device 10. According to the exemplary embodiment, although the display device 10 includes an edge type backlight unit, a space for accommodating the light source module 230 is positioned below the light guide 270. Accordingly, a space for accommodating the light source module 230 outside the screen S may be significantly reduced compared with a case where the light source module 230 is disposed substantially parallel to (e.g., in a same plane as) the light guide 270. Thus, a width covered by the top chassis 300, e.g., a bezel width W, may be reduced to, e.g., about 2.4 millimeters (mm) or less. The light-incident portion of the display device 10 is relatively thick in the third direction to accommodate the light source module 230 under and overlapping the light guide 270, but a remaining portion of the display device 10 except at the light-incident portion thereof may have a relatively thin thickness T of, e.g., about 6.9 mm or less.

The optical sheet 280 may be disposed between the frame 290 and the display panel 100 without being limited thereto. In an exemplary embodiment, the frame 290 may be omitted. Where the frame 290 is omitted, the side portion 212 of the bottom chassis 210 may further include a fourth portion that inwardly extends from the third portion 215 such that the optical sheet 280 and the display panel 100 may be disposed on the fourth portion. In another exemplary embodiment, the optical sheet 280 may be disposed between the light guide 270 and the frame 290. Where the optical sheet 280 is disposed between the light guide 270 and the frame 290, an adhesive layer such as a double-sided adhesive tape may be disposed between the frame 290 and the display panel 100 to fix the display panel 100 to the frame 290.

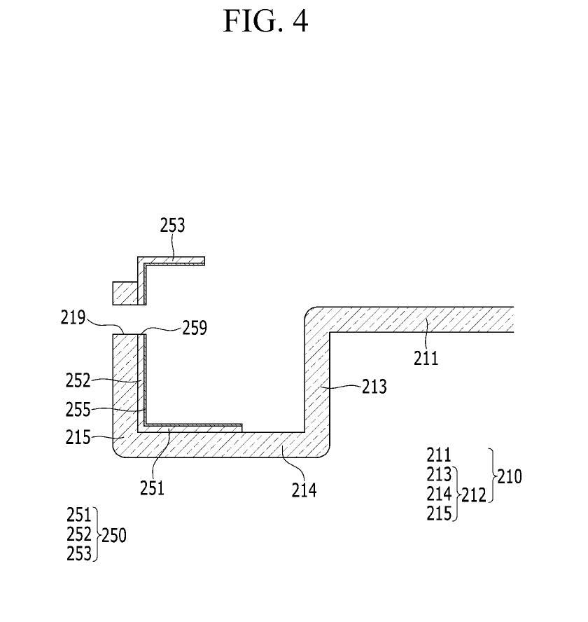

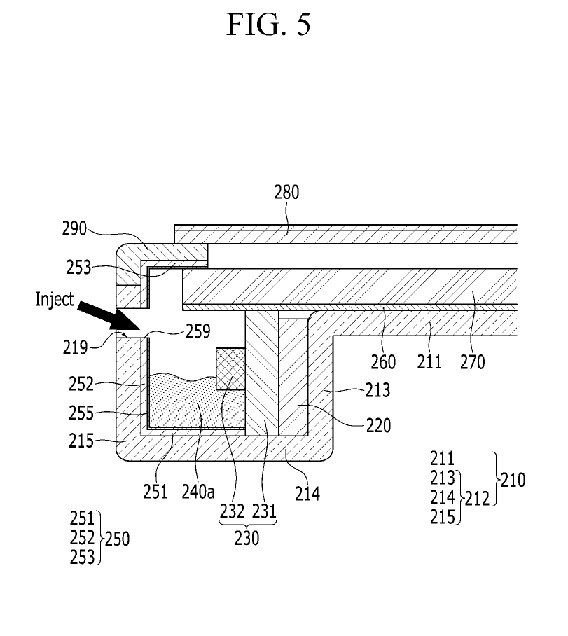

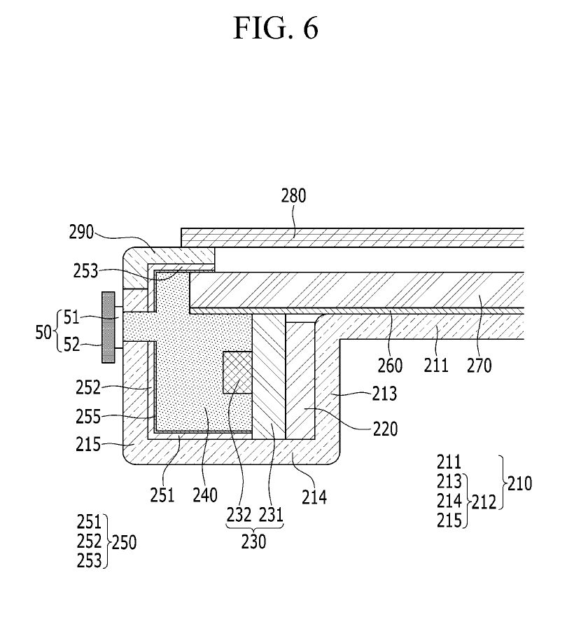

The display device according to the exemplary embodiment has been described in detail. Hereinafter, an exemplary embodiment of a manufacturing method of a display device according to the invention will be described focusing on formation of a refractive index matching member of the display device with reference to FIG. 4 to FIG. 6.

FIG. 4, FIG. 5, and FIG. 6 illustrate an exemplary embodiment of a manufacturing process of a display device according to the invention.

FIG. 4, FIG. 5 and FIG. 6 are cross-sectional views of an exemplary embodiment of a manufacturing process of the display device 10 of FIG. 1 to FIG. 3 described above, illustrating cross-sectional views of the light-incident portion of the display device 10 substantially corresponding to the cross-section of FIG. 3. However, the display device shown in FIG. 4 to FIG. 6 is different from that shown in FIG. 1 to FIG. 3 in that an injection hole 219 is disposed or formed in the bottom chassis 210 and an injection hole 259, which is aligned with the injection hole 219, is disposed or formed in the reflective member 250. One or a plurality of injection holes 219 and 259 may be formed in the third portion 215 of the side portion 212 of the bottom chassis 210.

Referring to FIG. 4, the injection hole 219 is formed in a base metal plate or the like for forming the bottom chassis 210, and then the bottom chassis 210 including the main portion 211 and the side portion 212 is formed by deforming the base metal plate such as through pressing thereof, bending thereof or the like. The injection hole 219 may be formed in the third portion 215 of the side portion 212 after the bottom chassis 210 is formed to include the side portion 212. The reflective member 250 having the injection hole 259 formed at a position corresponding to the injection hole 219 of the bottom chassis 210 is fixed to the side portion 212 of the bottom chassis 210, such as to inner surfaces at the side portion 212. The injection hole 259 may be positioned at the second portion 252 of the reflective member 250.

The reflective member 250 in FIG. 4 is shown to include the reflection layer 255 thereon to form an overall reflective member, but the invention is not limited thereto. Where the reflective member 250 has a reflective property without the reflection layer 255, the reflection layer 255 may be omitted.

Referring to FIG. 5, the support 220 and the light source module 230 are assembled at the side portion 212 of the bottom chassis 210, the reflective sheet 260 and the light guide 270 are positioned thereon, and the frame 290 is assembled thereto. The frame 290 may be coupled to the bottom chassis 210 in such a manner so as to be hooked onto a hook or the like that may be disposed on the side surface of the bottom chassis 210 while surrounding the side surface of the bottom chassis 210 (e.g., the third portion 215 of the side portion 212). In this case, the frame 290 may restrict movement of the light guide 270 and the reflective sheet 260 positioned therebelow by contacting the light guide 270 to press the light guide 270.

A resin material 240a, such as an optically transparent resin (“OCR”) with a refractive index that is similar to or substantially identical to a refractive index of the light guide 270, is injected (‘Inject’ in FIG. 5) into the light-incident portion space through the injection holes 219 and 259. The resin material 240a may be a thermosetting resin, a photo-curing resin, a two-component resin or the like.

Referring to FIG. 6, the resin material 240a is injected so as to completely fill the light-incident portion space and then cured to form the refractive index matching member 240. In a process of forming the refractive index matching member 240, the reflective member 250 may function as a mold for defining the region to be filled with the resin material 240a and for reducing or effectively preventing leaking of the resin 240a to other spaces or areas within the assembly. A sealing member such as a sealing tape 50 may be attached to the bottom chassis 210 at the injection hole 219. The sealing tape 50 may have a double-layer structure including a reflective layer 51 for increasing light utilization efficiency and a light-shielding layer 52 for reducing or effectively preventing light leakage at the injection hole 219. In an exemplary embodiment, the sealing tape 50 may be attached thereto before the resin 240a is cured.

The optical sheet 280 may also be assembled after the injection and curing of the optical transparent resin is completed. Thereafter, although not illustrated, the display device 10 may be manufactured by assembling the display panel 100 and the top chassis 300 which have been described above.

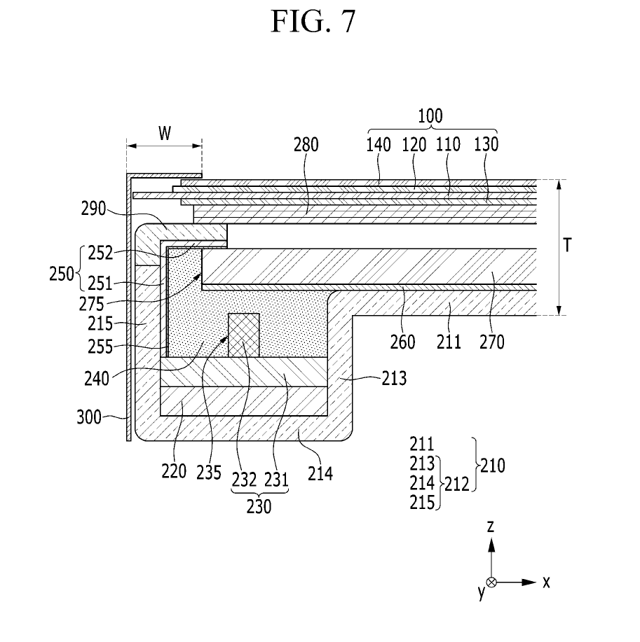

Hereinafter, a display device having a difference in types and disposals of the light source modules according to the aforementioned exemplary embodiments will be described focusing on the differences with reference to FIG. 7.

FIG. 7 illustrates enlarged cross-sectional view of another exemplary embodiment of a display device taken along line III-III′ of FIG. 1.

Referring to FIG. 7, in the side portion 212 of the bottom chassis 210, the support 220 is positioned in close proximity such as to be in contact with the second portion 214 of the side 212 and the light source module 230 is positioned above the support 220. A main surface of the support 220 and a main surface of the substrate 231 of the light source module 230 are substantially parallel, and are in parallel with a main surface of the light guide 270. The light source 232 which may be an LED package mounted in the substrate 231 is positioned so that the light emitting surface 235 faces an edge of the bottom chassis 210 adjacent to the light source module 230, that is, the third portion 215 of the side portion 212. As a result, the light source 232 may be a side view type of LED package with the main light-emitting surface 235 as a side surface of the mounting surface rather than a rear surface of the mounting surface. The main light-emitting surface 235 of the light source 232 may be substantially perpendicular to the main surface of the substrate 231. A width of the second portion 214 of the side portion 212 in the x-direction may be substantially equal to those of the support 220 and the substrate 231 to reduce the bezel width W.

The reflective member 250 may include the first portion 251 that contacts the third portion 215 of the side portion 212 and the second portion 252 that inwardly extends from the first portion 251, and may omit a portion that contacts the second portion 214 of the side portion 212. Light emitted from the main light-emitting surface 235 of the light source 232 toward the third portion 215 of the side portion 212 may be reflected by the reflective layer 255 of the reflective member 250 and introduced into the light-incident end portion 275 of the light guide 270. In this case, the light may pass through the refractive index matching member 240 without loss. As in the exemplary embodiment of FIG. 3, the light source module 230 may be disposed below the light guide 270 to overlap the light guide 270, thereby reducing the bezel width W of the display device.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A display device comprising:
a display panel which displays an image with light; and
a backlight unit which supplies the light to the display panel,
wherein the backlight unit includes:
a bottom chassis on which the display panel is disposed;
a light source module disposed along an edge portion of the bottom chassis and including a light source which generates and emits the light; and
a light guide which is disposed on the bottom chassis and transfers the light emitted from the light source to the display panel,
wherein at the edge portion of the bottom chassis:
the light source module is disposed between the bottom chassis and the light guide to overlap the light guide, and
a main light-emitting surface of the light source faces a side wall of the bottom chassis adjacent to the light source module.

2. The display device of claim 1, wherein
a light-emitting surface of the light guide defines a main surface thereof,
the light source module includes a substrate defining a main surface thereof on which the light source is mounted, and
the main surface of the substrate is perpendicular to the main surface of the light guide.

3. The display device of claim 2, wherein
the bottom chassis includes:
a main portion which is flat and on which the light guide is disposed, and
a side portion integral with the main portion, the side portion having a U-shaped cross-section extended away from the main portion, and
the light source module is disposed in the side portion of the bottom chassis.

4. The display device of claim 3, wherein the side portion of the bottom chassis includes:
a first portion which downwardly extends from the main portion in a direction away from the display panel;
a second portion which outwardly extends from the first portion in a direction away from the main portion, the second portion parallel with the main portion; and
a third portion which upwardly extends from the second portion in a direction toward the display panel, the third portion parallel with the first portion.

5. The display device of claim 4, wherein a hole is defined in the third portion of the side portion, the hole exposing an inner space of the side portion at which the light source module is disposed.

6. The display device of claim 4, wherein in the side portion in which the light source module is disposed, the backlight unit further includes a reflective member between the third portion of the bottom chassis and the light source module.

7. The display device of claim 6, wherein the reflective member has an C-shaped cross-section, a length of the reflective member extending along the edge portion of the bottom chassis to correspond to a length of the light source module.

8. The display device of claim 7, wherein the reflective member includes:
a first portion which contacts the second portion of the side portion;
a second portion which contacts the third portion of the side portion; and
a third portion which inwardly extends from the second portion of the reflective member in a direction toward the light guide, the third portion of the reflective member parallel with the first portion of the reflective member.

9. The display device of claim 6, wherein the reflective member includes a reflective layer at an inner surface thereof.

10. The display device of claim 9, wherein in the side portion in which the light source module is disposed, the backlight unit further includes a refractive index matching member between the reflective member and the light source module.

11. The display device of claim 10, wherein the refractive index matching member has a same refractive index as that of the light guide.

12. The display device of claim 11, wherein
the light guide includes a light-incident end surface facing the edge portion of the bottom chassis along which the light source module is disposed,
the backlight unit further includes a reflective sheet disposed between the bottom chassis and the light guide, and
at the side portion in which the light source module is disposed, the refractive index matching member contacts the reflective layer, the light source module, the light-incident end surface of the light guide and a lower surface of the reflective sheet.

13. The display device of claim 12, wherein in the side portion in which the light source module is disposed, the reflective sheet overlaps the light source module.

14. The display device of claim 4, wherein in the side portion in which the light source module is disposed, the backlight unit further includes a support disposed between the substrate of the light source module and the first portion of the side portion, to contact the substrate of the light source module and the first portion of the side portion.

15. The display device of claim 2, wherein the main light-emitting surface of the light source and the main surface of the substrate are parallel to each other.

16. The display device of claim 1, wherein the backlight unit further includes:
a frame disposed between the light guide and the display panel; and
an optical sheet disposed between the frame and the display panel.

17. The display device of claim 1, wherein
a light-emitting surface of the light guide defines a main surface thereof,
the light source module includes a substrate defining a main surface thereof on which the light source is mounted,
the main surface of the substrate is parallel with the main surface of the light guide, and
the main light-emitting surface of the light source is perpendicular to the main surface of the substrate.

18. The display device of claim 2, wherein
the bottom chassis includes:
a main portion which is flat and on which the light guide is disposed, and
a side portion integral with the main portion, the side portion having a U-shaped cross-section defined by:
a first portion which extends from the main portion in a direction away from the display panel;
a second portion which extends from the first portion in a direction away from the main portion, the second portion parallel with the main portion; and
a third portion which extends from the second portion in a direction toward the display panel, the third portion parallel with the first portion,
the light source module is disposed in the U-shaped side portion of the bottom chassis such that the main light-emitting surface of the light source faces the third portion of the side portion, and
the light guide includes a light-incident end surface through which the light emitted from the light source enters the light guide, the light guide extending from the main portion to dispose the light-incident end surface facing the third portion of the side portion.

19. The display device of claim 18, wherein within the U-shaped side portion in which the light source module is disposed, the backlight unit further includes a reflective member between the third portion of the bottom chassis and the main light-emitting surface of the light source and between the third portion of the bottom chassis and the light-incident end surface of the light guide.

20. The display device of claim 18, wherein within the U-shaped side portion in which the light source module is disposed, the backlight unit further includes a heat dissipating member disposed between the substrate of the light source module and the side portion of the bottom chassis.
